(19) United States
(12) Patent Application Publication
(10) Pub. No.: US 2009/0150779 A1
(43) Pub. Date: Jun. 11, 2009

(54) METHOD AND APPARATUS FOR DISPLAYING HELP INFORMATION

(75) Inventors: Noboru Kodama, Yokohama-shi (JP); Hidetoshi Mori, Yamato-shi (JP)

Correspondence Address: FERENCE & ASSOCIATES LLC, 409 BROAD STREET, PITTSBURGH, PA, 15143, US

(73) Assignee: Lenovo (Singapore) Pte. Ltd., Singapore (SG)

(21) Appl. No.: 12/329,486

(22) Filed: Dec. 5, 2008

(30) Foreign Application Priority Data
Dec. 6, 2007 (JP) 2007-315907

(51) Int. Cl. G06F 3/048

(52) U.S. Cl. 715/708

(57) ABSTRACT

A method of intelligently displaying help information that is easy for a user to use on a computer or similar electronic device is provided by the invention. An application window is displayed on a display device. A computer includes help information consisting of a plurality of records associated with each other in sequence of display including a first record and a second record displayed subsequent to the first record, as a database. Subsequently, a help window for displaying help information is displayed on the display device to display help information included in the first record. Event information related to event input by an input device with respect to the application window is acquired and help information included in the second record is displayed on the help window. A user can obtain help information necessary for subsequent operation from the help window.

### CLAIM FOR PRIORITY

This application claims priority from Japanese Patent Application No. 2007-315907, filed on Dec. 6, 2007, and which is fully incorporated by reference as if set forth herein.

### FIELD OF THE INVENTION

The present invention relates to a technique for display of help information to support a computer window operation by a user.

### BACKGROUND OF THE INVENTION

Electronic devices that process information include at least a personal computer (PC). A personal computer equipped with an operating system (OS) such as Windows®, MAC® OS or the like employs a graphical user interface (GUI) system in which a pointing device is used to input instructions with respect to a screen. In the GUI system, a user operates a computer by pointing and clicking a certain picture, figure, character or the like displayed on the screen with a pointing device such as a mouse, a track pad, a track ball or the like.

In a computer employing the GUI system, when an OS is executed, a desktop screen is first displayed. Then, a user can execute application programs to display separate screens for the application programs, which are called windows, on the desktop screen. Application windows are displayed in such a manner that an active window is displayed in the forefront of the desktop screen or small windows are displayed in parallel, or application windows are displayed to be minimized in a band-shaped task bar in the lowermost of the desktop screen. Although the number of application windows which can be displayed on the desktop screen at once is not restricted by the size of the screen, when a plurality of application windows overlap with each other or use a task bar in simultaneous execution conditions, a user can switch between the plurality of application windows in a short time and accordingly can performs a task with the plurality of application windows opened on the desktop screen.

Although a design for application window varies depending on the kind of OS or application software (hereinafter abbreviated as “application”), it is common that main menu items for operating a corresponding window are displayed by characters or combinations of characters and icons on an upper menu bar. In some application windows, sub menu items for a main menu item are displayed with a hierarchical structure in the form of a drop down menu or a dialog box. For example, a user may have to operate a plurality of menu items several times in order to perform a particular process such as double-sided printing on paper of a predetermined size.

Typically, application windows have respective help information, and if a user does not know how to operate a certain process, the user can operate a corresponding application window to open a help window and refer to help information displayed on the help window. If a user performs a process at the first time, the user can find out an operation sequence by referring to help information included in a corresponding application window or inquire of a person about the help information. A user may take notes for an operation sequence to be referred to. Japanese Laid-Open Patent Application No. Hei-5-210476 discloses a help message displayed by selection of a user during execution of a program. A help message window is determined to be optimized as the function of number and size of displayed elements.

Japanese Laid-Open Patent Application No. Hei-6-59846 discloses a man-machine interface device having a function of informing a user of an actual and correct operation sequence in the event of mistaken operation. Microsoft® Company describes how to perform a certain operation step by step using a keyboard for persons, who feel use of a mouse difficult, in comparison between mouse operation and keyboard operation. The guidance for this is introduced through an Internet site, which can be accessed with the URL: http://www.microsoft.com/japan/enable/training/default.mspx.

However, since help information included in application windows, or help information provided by an application provider through the Internet, is great in quantity, it may be difficult for a user to simply discover an operation sequence of a certain process. In addition, in order for a user to display an application window and its help information on a desktop screen to find out an operation sequence for a targeted process, there is a need to display a large help window, which may result in overlap of the help window with the application window.

When a user operates an application window according to help information of a help window, the application window is displayed on the forefront and the help window is concealed. In order to prevent this, it is necessary to adjust the size or display position of the help window or the application window. In addition, it may be difficult for a beginner to find out information, which is required for a process to be executed by the user, among detailed help information in a short time. Additionally, taking notes for detailed help information which is displayed and investigated by a user or about which a user inquires of a person is time consuming. In this manner, existing help information displayed on the desktop screen is not easy to use.

Thus, a need has been recognized for enabling a user to more easily obtain the help information required for operating an unfamiliar application, process, etc.

### SUMMARY OF THE INVENTION

In accordance with at least one presently preferred embodiment of the invention, there is broadly contemplated a method, a program storage device and an apparatus for implementing a method, for displaying help information, which can be easily used by a user, on a computer or similar electronic device.

In summary, one aspect of the invention provides a machine implemented method comprising: storing a plurality of help information records in a memory of the machine, the plurality of help information records comprising: a first record and at least one subsequent record; displaying an application window on a display device of the machine; displaying the first record in a help window on the display device; acquiring event information generated by an input operation at a user interface associated with a user operating an application displayed in the application window; and displaying the at least one subsequent record in response to the acquired event information in the help window.

An additional aspect of the invention provides an apparatus comprising: a processor; a display device; a user interface; and a memory; wherein the memory tangibly stores a program of instructions executed by the processor to perform method steps, the method steps comprising: storing a plurality of help information records in the memory, the plurality of help information records comprising: a first record and at least one subsequent record; displaying an application window on the display device; displaying the first record in a help window on the display device; acquiring event information generated by an input operation at the user interface associated with a user operating an application displayed in the application window; and displaying the at least one subsequent record in response to the acquired event information in the help window.

A further aspect of the present invention provides a tangible program storage device readable by machine, tangibly embodying a program of instructions executable by the machine to perform method steps, said method steps comprising: storing a plurality of help information records in a memory of the machine, the plurality of help information records comprising: a first record and at least one subsequent record; displaying an application window on a display device of the machine; displaying the first record in a help window on the display device; acquiring event information generated by an input operation at a user interface associated with a user operating an application displayed in the application window; and displaying the at least one subsequent record in response to the acquired event information in the help window.

For a better understanding of the present invention, together and with other and further features and advantages thereof, reference is made to the following description, taken in conjunction with the accompanying drawings, and the scope of the invention will be pointed out in the appended claims.

### BRIEF DESCRIPTION OF THE DRAWINGS

FIG. 1(a-b) is a view for explaining a structure of an application window.

FIG. 2(a-b) is a view for explaining another structure of an application window.

FIG. 3(a-b) is a block diagram showing a general configuration of a computer according to an embodiment of the present invention.

FIG. 4 is a master flow chart illustrating a sequence of displaying help information according to an embodiment of the present invention.

FIG. 5 is a flow chart illustrating a sequence of constructing a database of help information in a computer.

FIG. 6 is a view showing 7 records of help information recorded with regard to operations from a first step to a seventh step which are performed by a user for printing.

FIG. 7(a-b) is a view showing a data structure of help information.

FIG. 8 is a view showing a data structure of a database.

FIG. 9 is a flow chart illustrating a sequence of displaying help information in a computer.

FIG. 10(a-c) is a view for explaining a help window.

FIG. 11 is a view showing a logic table used to determine whether or not a display operation is stopped.

### DETAILED DESCRIPTION OF THE INVENTION

It will be readily understood that the components of the present invention, as generally described and illustrated in the Figures herein, may be arranged and designed in a wide variety of different configurations. Thus, the following more detailed description of the embodiments of the apparatus of the present invention, as represented in the figures, is not intended to limit the scope of the invention, as claimed, but is merely representative of selected embodiments of the invention.

Reference throughout this specification to “one embodiment” or “an embodiment” (or the like) means that a particular feature, structure, or characteristic described in connection with the embodiment is included in at least one embodiment of the present invention. Thus, appearances of the phrases “in one embodiment” or “in an embodiment” in various places throughout this specification are not necessarily all referring to the same embodiment.

Furthermore, the described features, structures, or characteristics may be combined in any suitable manner in one or more embodiments. In the following description, numerous specific details are given to provide a thorough understanding of embodiments of the invention. One skilled in the relevant art will recognize, however, that the invention can be practiced without one or more of the specific details, or with other methods, components, materials, etc. In other instances, well-known structures, materials, or operations are not shown or described in detail to avoid obscuring aspects of the invention.

The illustrated presently preferred embodiments of the invention will be best understood by reference to the drawings, wherein like parts are designated by like numerals or other labels throughout. The following description is intended only by way of example, and simply illustrates certain selected presently preferred embodiments of devices that are consistent with the invention as claimed herein. The description provides a detailed description of preferred embodiments according to the present invention.

When operating an electronic device (for example, a computer), many users have a tendency to repeat an experienced process or perform a simple process rather than perform a difficult operation such as using all help information included in an application window. While a skilled user may easily remember an experienced operation, a beginner may have to take complicated sequences for operation as unfamiliar each time. One embodiment of the invention therefore provides a method of displaying help information, which can be easily used by a user, on a computer. One embodiment of the invention also provides a computer program for causing a computer to implement such a displaying method and a computer that is capable of implementing such a displaying method.

According to one embodiment of the instant invention, a computer stores help information consisting of a plurality of records associated with each other in sequence of display. When records are associated and organized in the display sequence, they may be arranged in sequence in a list format or may be associated with pointers. The display sequence corresponds to an operation sequence for a particular process with respect to an application window. An application window and a help window are displayed at once on a display device. When help information included in a first record is displayed on the help window, a user can operate the application window according to the help window. Subsequently, in response to acquisition of event information related to an event generated by operation performed by a user through an input device with respect to the application window, help information included in a second record displayed next to the first record is displayed on the help window.

Since a user can simply obtain help information required for the next operation for a particular process from the help window displayed on the same display device, there is no need to search for information required for the next operation from detailed help information prepared in an application. Here, the application window includes not only an upper level window first displayed when an application starts, but also a lower level window, such as a drop down menu, a dialog box or the like, displayed according to the upper level window.

When only the help information included in the second record required for the next operation is displayed on the help window, since the size of the help window can become small, it is pertinent in that there is no difficulty in operating the application window. When a record includes image operation information representing an operation object, operation contents can be visualized, thereby making it easy for a user to understand operation. When the image operation information corresponds to images of small areas of the application window centered at a location of a mouse cursor or a keyboard cursor manipulated by a user, it is possible to make the size of the help window small. Additionally, by displaying image position information representing a position of the image operation information with respect to the application window, it is easy for a user to use the help window.

When a help window is displayed on the forefront with respect to all application windows or on a location at which the help window does not overlap with the application windows, it is easy for a user to operate the help window while seeing the help window. By comparing help information included in the first record with acquired event information, a user can monitor whether or not the user performs a correct operation based on the help information. If it is determined that the user performs an incorrect operation, an alarm or a caution is given to the user. If an operation object of help information does not correspond to a selected item, since there is a high possibility of performing an operation different from displayed help information and accordingly it is not possible to provide useful information even when later records are displayed, display of the help information included in the second record is stopped.

However, if the help information included in the first record after the stop (information displayed on the help window) matches the event information generated by manipulation by a user through an input device, when the help information included in the second record is displayed, in a case where the user performs an incorrect operation and corrects it to be a correct operation, display of the help information can restart thereafter to use the help window.

When display of the help information included in the second record is stopped, if the display state of the help information included in the first record is maintained in the help window, it is possible to wait until a user perform a correct operation according to the first record. If at least one of an operation method and a title included in the help information does not match event information, since there is a high possibility that a user can realize an intended process by using help information displayed thereafter, a caution may prompt the user to display the help information included in the second record. By displaying a list of process items for selecting help corresponding to a process intended by a user on the help window, it is possible to cause the user to select a file of help information related to an intended process item.

Help information can be formed by generating records by recording information related to a series of operations for a particular process through an input device with respect to an application window, every operation unit. In this case, a user may leave any operation sequences that the user wishes to memorize, among operation sequence experienced by himself, in a database, as a file of help information, or may share the file with other persons by delivering the file to them.

Referring now to the figures, the instant invention will be described with reference to the figures herein and the scope of the invention will be pointed out in the pending claims.

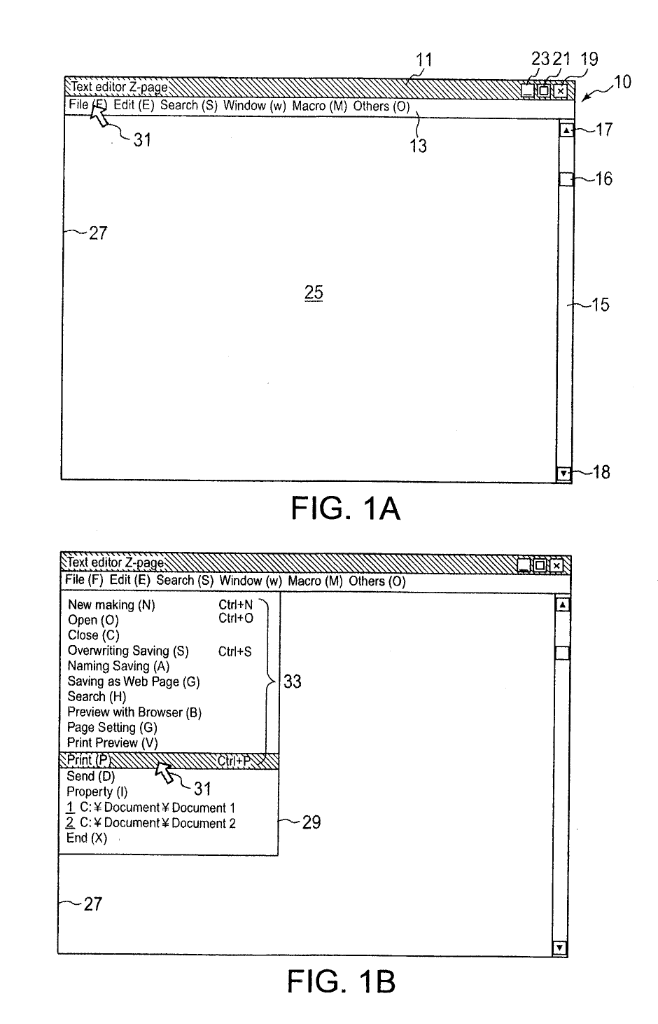

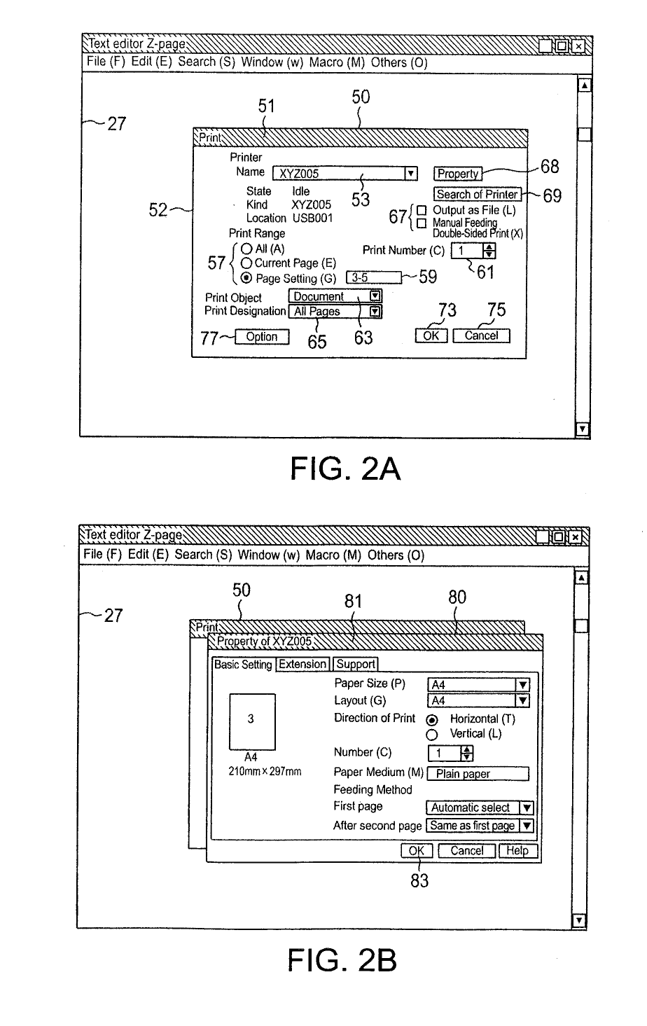

FIGS. 1 and 2 are views of an exemplary embodiment of the instant invention showing a structure of an application window. The application window may be generated by an application operating on an OS, such as Windows (registered trademark) or MAC OS (registered trademark), having a GUI. An application window 10 is a data structure composed of a plurality of elements managed by an OS, and is shown as a region surrounded by a window frame 27 in FIG. 1A. A title bar 11 disposed in an upper portion of the window frame 27 is an area for displaying a title of the application window 10. Although a character string represented as the title may be arbitrarily set by an application, it here represents an application name, Text Editor Z, and a name of a file being currently edited: —page.

A menu bar 13 is shown below the title bar 11. The menu bar 13 includes 6 menu items, i.e., File (F), Edit (E), Search (S), Window (W), Macro (M) and Others (O), all of which are to be operated by a mouse or a keyboard or any suitable user interface. The menu items of the menu bar 13 are objects to be operated with characters as types. Most of the window frame 27 is occupied by a client area 25 in which a user uses an application to perform a task. A vertical scroll bar 15 is shown in the rightmost of the window frame 27. The vertical scroll bar 15 is used to scroll the client area 25 by operating a knob 16 or arrows 17 and 18 by means of the mouse. The window 10 further includes a close button 19, a maximization button 21 and a minimization button 23. Although it is shown in the figure that the window 10 has a basic structure required for description of the present invention, it may include other objects that are not shown in the figure; the same principle applies throughout this description.

A user performs an intended process by manipulating a mouse or a keyboard with respect to the application window 10. A program format to perform the process by the manipulation of the user is referred to as “event-driven.” In order to operate an even-driven type application, the OS detects event information generated by the mouse or keyboard manipulation. The OS has a multi-window function to display a plurality of application windows, which are generated by each application, on a screen of a computer. Events generated by a hardware, such as the mouse or the keyboard, for a particular application window are detected by a device driver and are added, as window messages (hereinafter abbreviated as messages), in regular sequence, to a system queue managed by the OS.

When a plurality of application windows are opened and a user clicks a location of an application window intended by the user, the application window displayed at a rear side appears as a focus window in the forefront of the screen with change of color of the title bar. The OS informs each application of event information generated by the mouse or the keyboard using a data structure called a message.

The message is composed of information including a window handle, which is an integral number for identifying a window to be a recipient of the message, an ID for identifying the kind of message, an operation method such as a left button or a right button of the mouse, a position of a mouse cursor when an event occurs, etc. The OS takes out messages stored in the system queue from the head of the system queue in order, specifies an application corresponding to the focus window when the event occurs, and adds a message to the message queue prepared for each application. A window procedure is registered with each of elements of the application window.

The window procedure is a function to process a window message. An application takes messages out of the message queue in order and delivers them to the window procedure. The window procedure performs a process corresponding to the event information by applying an argument included in the window message to the function. The application uses system call functionality of the OS to entrust the OS with subsequent processes corresponding to the message. In this manner, the application uses the function of the OS to process the operation performed by the user for the application window.

FIG. 1B shows a state where a user clicks a mouse left button with a mouse cursor 31 placed on a menu item of File (F) displayed on the menu bar of FIG. 1A. The click refers to a series of activities to quickly press and drop the mouse button with the mouse button placed on a certain location. The click may include a single click and a double click that may be reversed with respect to each other for response operation. In addition, functions of mouse left and right buttons may be adequately switched between a right-handed user and a left-handed user. In this embodiment, although it is illustrated that a right-handed user singly clicks the mouse left button, a mouse clicking method is not particularly limited.

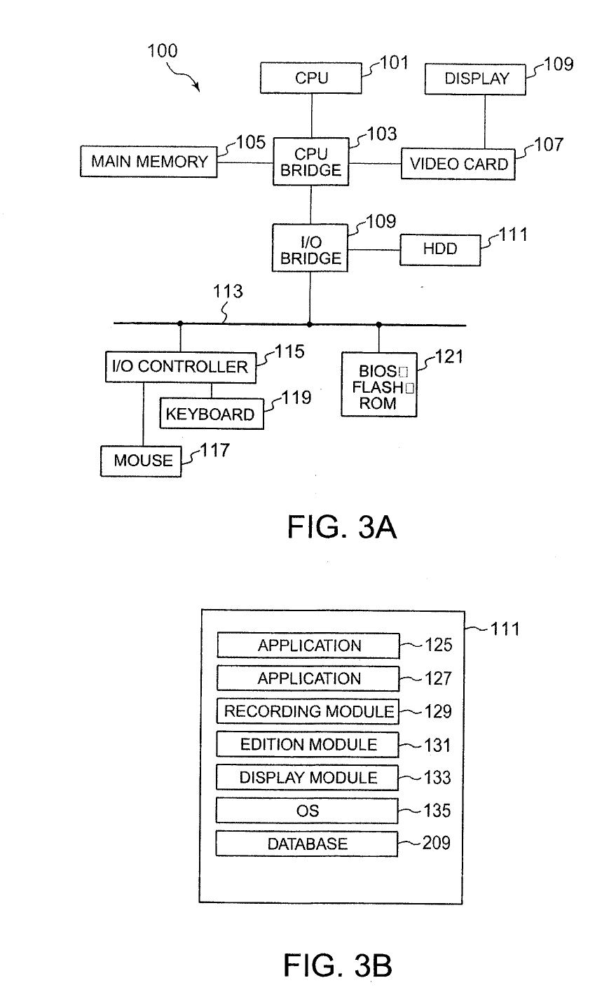

When the OS generates a message for an event generated by the click on the File (F) menu item, a window procedure is registered with the File (F) menu item of the application window 10. When the window procedure performs a process corresponding to the message so that the application calls a system call of the OS, the OS displays a plurality of sub menu items corresponding to the File (F) menu item within a drop down menu 29. Hereinafter in the exemplary descriptions, processes for mouse or keyboard manipulation by a user with respect to hierarchical sub menu items are performed in the same sequence between the application window 10 and the OS 135 (see FIG. 3B).

In this example, like the menu items, the sub menu items are objects to be operated with characters as types. The drop down menu is a part of the data structure of the application window 10 and is displayed in an area predetermined in connection with the File (F) menu item. When the mouse cursor 31 is moved to a location of the drop down menu 29, a sub menu item at the location is highlighted so that the user can know a selected content. In FIG. 1B, a Print (P) sub menu item is selected, and when the mouse button is clicked with the mouse cursor 31 placed on that position, the Print (P) sub menu item is executed.

The operation of clicking a menu item to display the drop down menu 29 and additionally selecting, clicking and executing a sub menu item in this manner is here temporarily referred to as “click&select.” In the click&select, the drop down menu 29 displayed by the first click does not disappear even when the mouse cursor 31 is moved out of the drop down menu 29. In the click&select, clicks are twice made in order to execute a sub menu item of the drop down menu 29. In this case, each click becomes an operation unit in this embodiment. The operation unit is the unit of instruction to a computer by a user to generate a record of help information.

According to at least one embodiment of the instant invention, as an alternative method for executing a sub menu item of the drop down menu 29 with the mouse cursor 31 placed on File (F) of the menu bar 13 and with the mouse button pressed, the Print (P) sub menu item can be executed, like the click&select, by dragging and dropping the mouse cursor 31 to Print (P) of the drop down menu 29. This is temporarily referred to as “drag&select.” In the drag&select, when the mouse button is first pressed to open the drop down menu 29 and then the mouse cursor 31 is dragged and dropped out of the drop down menu 29, the drop down menu disappears from the screen without any sub menu item being selected.

The pressing and dropping operations of the mouse button performed with the click&select become the operation unit in this embodiment. With operations having the same contents, the drag&select generates the same records as the click&select. Since key manipulation of the keyboard can correspond to the manipulation of clicking the menu items and the sub menu items by the mouse, the menu items and the sub menu items can be selected and executed through the keyboard instead of the mouse. FIG. 1B shows 4 key manipulation items 33, “Ctrl+N”, “Ctrl+O”, “Ctrl+S” and “Ctrl+P”, on the drop down menu 29. For example, when a Ctrl key and a P key are pressed at once, the same result as the clicking of the Print (P) sub menu item by the mouse button can be obtained. In this case, the simultaneous pressing of the Crtl and P keys become the operation unit in this embodiment. It will be readily understood by one of skill in the art that in addition to the above examples, other ways for entering inputs via a user interface can be accommodated by the instant invention.

When the Print (P) sub menu item in the drop down menu 29 is executed, a dialog box 50 is displayed in the middle of the window frame 27, as shown in FIG. 2A. A display location of the dialog box 50 is set by a window procedure registered with the application window 10. The dialog box 50 is a window allowing a user to make settings for print. The dialog box 50 is a part of the data structure of the window 10. Although the dialog box 50 is more often than not set to be first displayed in the middle of the window frame 27, a user may move the displayed dialog box 50 to any locations including the outside of the window frame 27 by dragging a title bar 51 of the dialog box 50.

A character of “Print” as the title of the dialog box 50 is displayed in the title box 51. Although a title of an operation object of the drop down menu 29 performed to open the dialog box 50 is displayed in the title bar 51, other titles may be displayed depending on applications. Many operation objects and select items are displayed within the window frame 52.

An operation object of “printer_name”, an operation object of “print object” and an operation object of “print designation” have select windows 53, 63 and 65 as their types, respectively. An operation object of “print number” has a select window 61 as its type. The operation objects having the select windows 53, 63 and 65 as the types display select items when a user clicks a down button disposed in the rightmost of each select window. In each of the select windows 53, 63 and 65, a list box is displayed to show all inner select items when the respective down button is clicked. The user selects a select item required for a print process with click&select or drag&select. Here, an operation is performed in the unit of two operations in either the click&select or the drag&select, like the operation to display the list box 29.

In the operation object having the select window 61 as the type, a displayed numerical value is changed by clicking down and up buttons displayed in the rightmost of the select window 61. Here, once click of the down button or the up button is the unit of operation. An operation object of “print range” has radio buttons 57 corresponding to select items of “All (A),” “Current Page (E)” and “Page Designation (G)” as its type. The operation object having the radio buttons 57 as the type can be selected by clicking only a radio button corresponding to one of the select items. Here, the operation to click one of the three radio buttons 57 is the unit of operation. The select item of “Page Designation” is an operation object of “Print Range Page Designation” having an input box 59 as its type simultaneously.

The operation object having the input box 59 as the type sets a select item by inputting a numeral therein with the keyboard. Here, the completion of input of all required numerals is the unit of operation. An operation object of “Printer” has check boxes 67 corresponding to select items of “File Output (L) and “Manual Feeding Double-Sided Print (X)” as its type. The operation object having the check boxes 67 as the type is selected by marking one check mark by clicking one of the check boxes. Even when this operation object is once selected, it may be released by erasing the marked check mark by clicking the check box again.

Here, once click of the check boxes is the unit of operation. In addition, the dialog box 50 further includes operation objects having a property button 68, a printer search button 69, an option button 77, an OK button 73 and a cancel button 75 as their types. The operation objects having these buttons as the types can be executed by clicking these buttons. When the OK operation object 73 is clicked, printing starts. Setting for a printer additionally selected may be made in the process of printing. When the operation object having the property button in FIG. 2A is clicked with a mouse left button, a dialog box 80 shown in FIG. 2B is displayed in the forefront of the screen with it overlapping with the dialog box 50.

A character, “Property” of XYZ005 which is a title of a printer, is displayed in a title bar 81 of the dialog box 80. The dialog box 80 is a window for making detailed settings for the printer XYZ005 for the printing process. The dialog box 80 includes select boxes, a plurality of operation objects having radio buttons, characters and so on as their types, and select items. Operation methods and operation units therefor are similar to those described above for the dialog box 50. Finally, when a user clicks an operation object 83, the dialog box 80 is closed and returns to the dialog box 50. When the user clicks the OK operation object 73 in the dialog box 50, the printer prints with it set to a default value although the dialog box 50 is not displayed. The dialog boxes 50 and 80 are parts of the application window 10.

FIG. 3A is a block diagram showing a general configuration of a computer 100 according to an embodiment of the instant invention. A CPU 101 is a processor having the central function of the computer 100 and executes an OS, a BIOS, device drivers, application programs, other programs related to the present invention, and so on. A CPU bridge 103 includes a memory controller function for controlling access to a main memory 105, a data buffer function for absorbing a difference in data transfer rate between connected devices, and so on. The main memory 105 is a writable memory used as a read area of programs executed by the CPU 101 and a work area for writing processed data. A video card 107 includes a video chip (not shown) and a VRAM (not shown), generates an image to be drawn, based on a drawing instruction received from the CPU 101, reads the image into the VRAM, and sends an image, which is read from the VRAM, as drawing data, to a display 109.

The display 109 displays a desktop screen, an application window, a help window related to this embodiment, etc. An I/O bridge 109 is a device controller constituting a chip set like the CPU bridge 103. The I/O bridge 109 has an IDE (Integrated Device Electronics) interface function and is connected with a magnetic disk storage (HDD) 111. As shown in FIG. 3B, the HDD 111 stores an OS 135 and application programs 125 and 127. The HDD 111 further stores an recording module 129, an edition module 131, a display module 133 and a database 209, all of which are related to the present invention. The I/O bridge 109 is connected to devices, which do not require high speed data transfer, via an LPC bus 113. The LPC bus 113 is connected with a BIOS flash ROM 121 and an I/O controller 115. The I/O controller 115 is connected to input devices such as a mouse 117, a keyboard 119 and the like.

All of the application programs 125 and 127, the recording module 129, the edition module 131 and the display module 133 are window programs operating on the OS 135. The recording module 129, the edition module 131 and the display module 133 are programs for displaying help information in a help window related to at least one embodiment of the invention. The recording module 129 and the display module 133 reside in the main memory once they are executed, and are serviced for all applications.

The database 209 is a collection of help information generated by the recording module 129 and edited and constructed by the edition module 131. The OS 135 has a multi-window system function and can open a plurality of application windows on the desktop screen simultaneously.

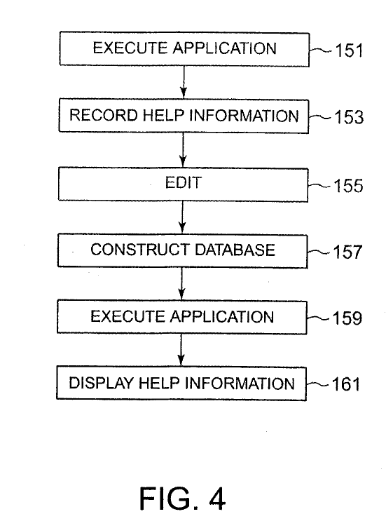

FIG. 4 is a master flow chart illustrating a sequence of displaying help information according to at least one embodiment of the invention. A user generates or collects help information, apart from help information included in the application window. The user constructs the database 209 by editing and accumulating the generated or collected help information and displays help information based on the database 209 during execution of an application. In Block 151, one or more applications are executed to collect help information. In Block 153, the user performs a series of operations for the application window in order to perform a particular process for an application, such as printing, transmission and format change, and records help information for every operation unit.

Such operations are performed by reading the help information of the application window, learning help information from a person, or through trial and error. The series of operations may span over a plurality of application windows as well as one particular application window. In Block 155, the recorded help information is edited to appropriately display help information, and in Block 157, the help information is systemized to construct the database 209. The sequences up to here are performed for each particular process and a name called a process item is given to one process. Subsequently, in Block 159, the application window and the help window, both of which use the help information, are simultaneously opened, and in Block 161, help information required for operation of the application window is automatically displayed in the help window in order with progress of operation by the user.

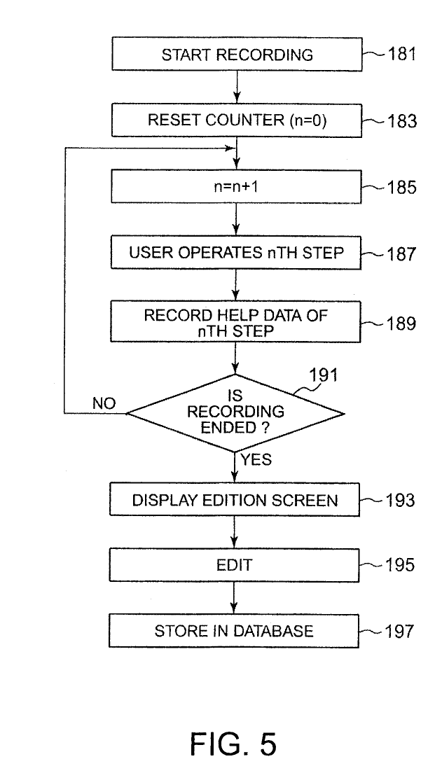

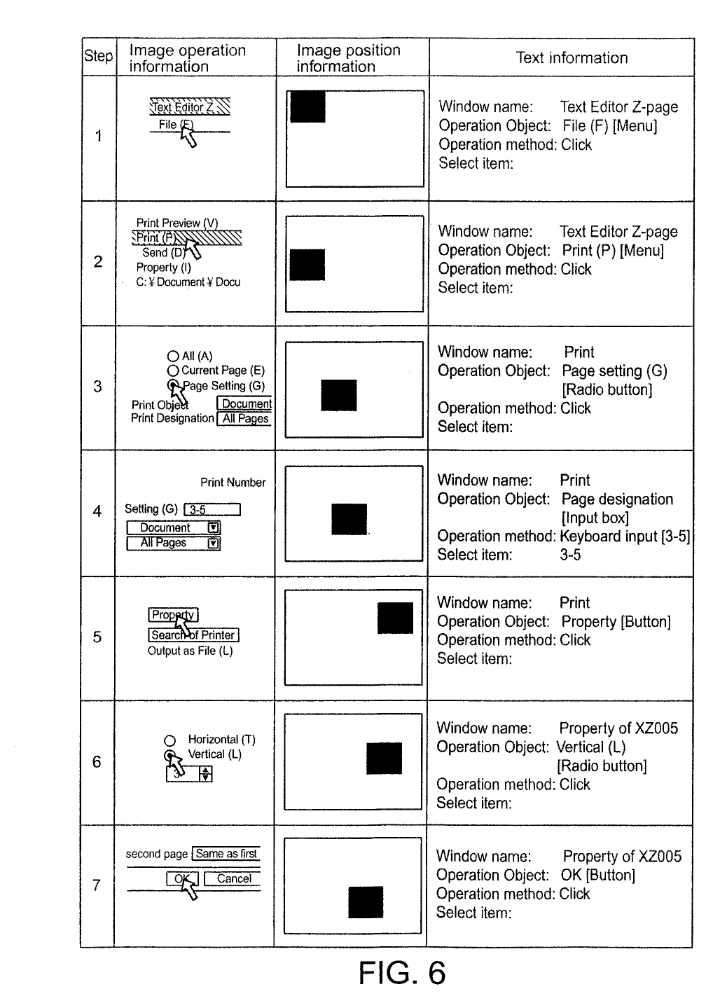

FIG. 5 is a flow chart illustrating a sequence of constructing the database 209 of help information in the computer 100. FIG. 6 is a view showing a data structure of a file of help information recorded for each operation unit with regard to operations from a first step to a seventh step which are performed by a user for printing. In FIG. 5, a user reads one or more applications, for which help information is to be collected, from the HDD 111 into the main memory 105 and then displays the read help information on the display 109. In this embodiment, it is assumed that the application window 10 as shown in FIGS. 1 and 2 are displayed. In Block 181, the user reads the recording module 129 from the HDD 111 into the main memory 105 and starts the recording module 129. The recording module 129 displays a recording window on the forefront of the display 109 so that the user can confirm help information to be recorded.

When the user makes an operation of recording start for the recording window, the recording module 129 resets its own internal counter to set a count value n to zero. Subsequently, in Block 185, the recording module 129 sets the count value n to n+1. The count value n corresponds to a step of operation performed by the user and is incremented every operation unit. In Block 187, the user starts an operation for predetermined processing with respect to the application window 10. The operation performed by the user is recorded every operation unit as described above. It is here assumed that the user performs a process of horizontally printing through page 3 to page 5 of a file prepared in the text editor Z application shown in FIGS. 1 and 2. While the printing is required to be executed by clicking the OK operation object 83 after setting a plurality of select items displayed in the dialog boxes 50 and 80, the text editor Z retains a default value for each select item and first presents the default value to the user.

In some cases, the text editor Z may present the most recent value selected by the user to the user, as a default value. At any rate, by clicking an operation object of the menu bar 13 or the drop down menu 29 or confirming a select item of the dialog box 50 or 80, the user performs an intended process while changing the selected item if necessary.

As a first operation for printing, the user clicks the mouse cursor 31 placed on the character type operation object of “File (F) of the menu bar 13. An event of click with respect to File (F) is performed by a window message and a system call between the OS 135 and the application window 10 of the text editor Z. The recording module 129 is configured to hook event information related to processing of the event of window message or system call. Upon detecting the event information indicating that the File (F) operation object is clicked, the recording module 129 records help information at a moment when the event occurs, based on the operation unit. FIG. 6 shows a data structure of the recorded help information. The help information consists of a plurality of records of one file for a particular process item, each record including fields of a step, image operation information, image position information and text information. Each record is generated for every operation unit as described above. The step refers to consecutive numbers assigned every operation unit for operations performed in order for a particular process by a user.

The image operation information refers to images of the application window 10 having a size of 240 dot×180 dot, which is centered at a position of a mouse cursor or a keyboard cursor that generates an event. Since the image operation information consists of image around the mouse cursor or the keyboard cursor, this information can be easily understood as help information. In other words, even an unskilled user can quickly obtain most of information required for operation from the image operation information. In addition, when only the image operation information is displayed, it is possible to increase a space efficiency of help information since a space for the help window may be small.

The image position information refers to images representing a position of the image operation information within the window frame 27. The text information is information related to operation and includes a window name, an operation object, an operation method and a select item. The window name is a name displayed in a title bar. The operation object consists of titles of operation objects such as File (F) and types of operation objects such as menus, buttons, select boxes, radio buttons and the like. The user can use only the text information to obtain help information required for operation.

The operation method refers to an operation method of the mouse 117 or the keyboard 119, such as click, key input or drag. The click may be represented in detail, like a left click and a single click. Data of such help information is received in the recording module 129 from the OS 135 every operation unit.

In Blocks 187 and 189, the recording module 129 first records help information related to operation of a first step. Subsequently, the flow proceeds to Block 191 to determine whether or not the recording of help information is ended. The end of the recording is executed when the user ends the recording window of the recording module 129. If the recording is not ended in Block 191, the flow returns to Block 185 where an operation of a next step by the user is waited and help information is recorded likewise. The recorded help information is once stored in the main memory 105 in order of recording.

The first step in FIG. 6 is a record of help information when the File (F) operation object of the menu bar 13 is clicked. A second step is help information when the Print (P) operation object of the drop down menu 29 is clicked. A third step is help information when a radio button corresponding to the Page Designation (G) operation object of the dialog box 50 is clicked. A fourth step is help information when 3-5 is input, as a select item, in the Page Designation operation object of the dialog box 50 with a keyboard.

Here, a keyboard cursor other than a mouse cursor is displayed in the left of number 5 in an input box. A fifth step is help information when the Property operation object of the dialog box 50 is clicked. A sixth step is help information when a radio button corresponding to the Horizontal (L) operation object of the dialog box 80 is clicked. A seventh step is help information when the OK operation object 83 of the dialog box 80 is clicked.

After the seventh step is executed, the user performs a printing operation with intended contents and then ends the recording related to this process with respect to the recording window of the recording module 129 in Block 191. The recording operation of the help information is ended by Block 191. The help information is not limited to the operation performed for one application but may be applied to operations performed for a plurality of applications. In addition, the recording module 129 may be always activated, while normally operating an application, to store about 100 records of help information every operation unit in the main memory 105 in a FIFO (First-In First-Out) manner, and may store the help information in the database 209 in an order, which will be described later, when the user performs an operation to leave the records as help information.

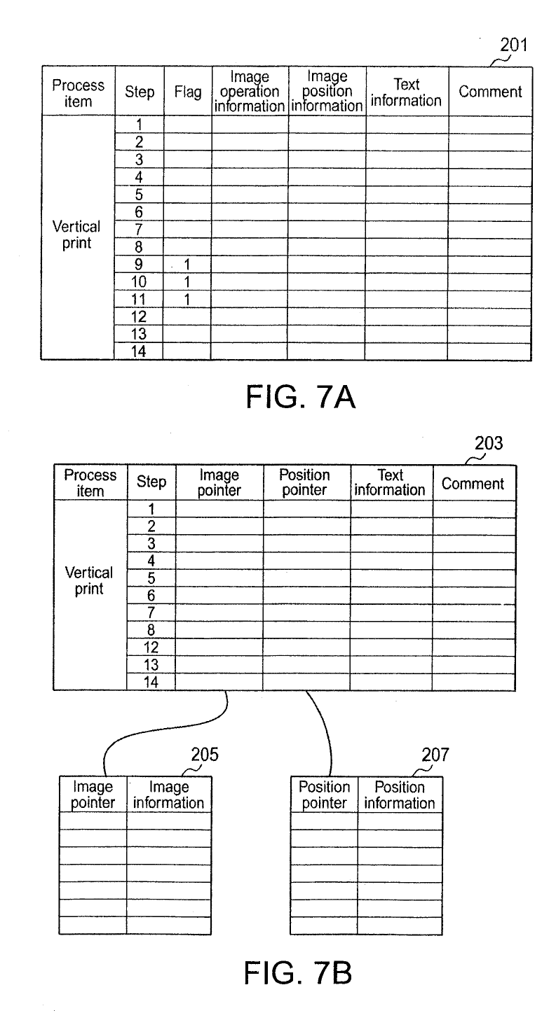

Subsequently, in Block 193, the user starts the edition module 131 to open an edition window in the desktop screen. FIG. 7A shows a file 201 of help information displayed in the edition window. Here, the file 201 consists of records corresponding to 14 operation units performed for an intended process by a user, and 7 fields including a process item, a step, a flag, image operation information, image position information, text information and a comment. For the purpose of convenience of description, the records of the file 201 have no relation to the records of the file shown in FIG. 6. Among these fields, the image operation information, the image position information and the text information has the same data structure as those shown in FIG. 6. The fields of process item, step, flag and comment are fields newly prepared by the edition module 131.

The process item is a field into which a user randomly writes a title related to a process. Here, the user inputs text information, ‘horizontal print’, in the process item to facilitate reference for a later process. The flag is set by inputting “1” thereto and is used to make a particular record into a non-displayable state. When help information is recorded in a sequence from Block 181 to Block 191 of FIG. 5, the records of help information recorded every operation unit may be redundant as information displayed in the help window later.

For example, when “3” is selected as a print number by clicking the up button twice in the select box 61 of FIG. 2A, 3 help information records displayed with “1”, “2” “3”, respectively, are recorded in the select box. Since states displayed with “1” and “2” should not be included in the displayed help information, the edition module 131 may be deleted from the help information displayed in the help window by setting a flag in such a record by a user.

The comment is prepared to allow a user to record additional information as a text in case where the help information recorded as each record is insufficient as help information displayed in the help window. For example, although a desired object of a plurality of printers is selected in the input box 53 of FIG. 2A, in case where names of printers to be selected in case of color printing and black-and-white printing are different from each other, the names of printers and distinction between color printing and black-and-white printing may be recorded in the comment field.

FIG. 7B shows a data structure of a file 203 generated when a user additionally edits the file 201 using the edition module 131. The file 201 consists of a plurality of records for one process item and also includes image operation information and image position information. As the number of files increases, a space in the HDD 111 where help information is stored becomes larger. In the meantime, a file for each process item includes common image operation information and image position information. For example, both of the records of the first and second steps in FIG. 6 are included in each of a plurality of files of process items related to printing.

Accordingly, when the image operation information and the image position information are incorporated into an image file 205 and a position file 207, respectively, and logical addresses of the image operation information and the image position information of a corresponding record are recorded in fields of an image pointer and a position pointer in association therebetween, there is no need to record the image operation information and the image position information in respective files in an overlapping manner. When a user sets a flag and additionally records a required comment and the edition module 131 forms the files 203, 205 and 207, the editing operation in Block 195 is ended.

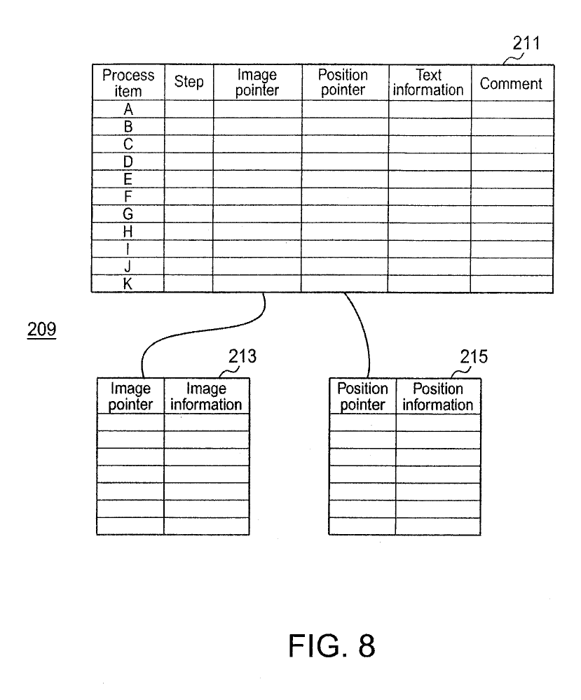

Next, in Block 197, the file 203, the image file 205 and the position file 207 are additionally stored in the database 209 of the prepared help information stored in the HDD 111. FIG. 8 shows a data structure of the database 209 stored in the HDD 111. The database 209 is composed of a main file 211 consisting of 11 files A to K, an image file 213 and a position file 215. The file 203 is added to the main file 211, the image file 205 is added to the image file 213, and the position file 207 is added to the position file 215. The main file 211 also may be configured such that a user can easily find out a process item corresponding to an intended process when help information is displayed with grouped and layered process items. In addition, files of help information may be shared between a plurality of users by generating files in the unit of file corresponding to a process item needed by a user, receiving files generated in other computers and adding the files to the database 209, or sending or distributing files to other computers via a network (connection).

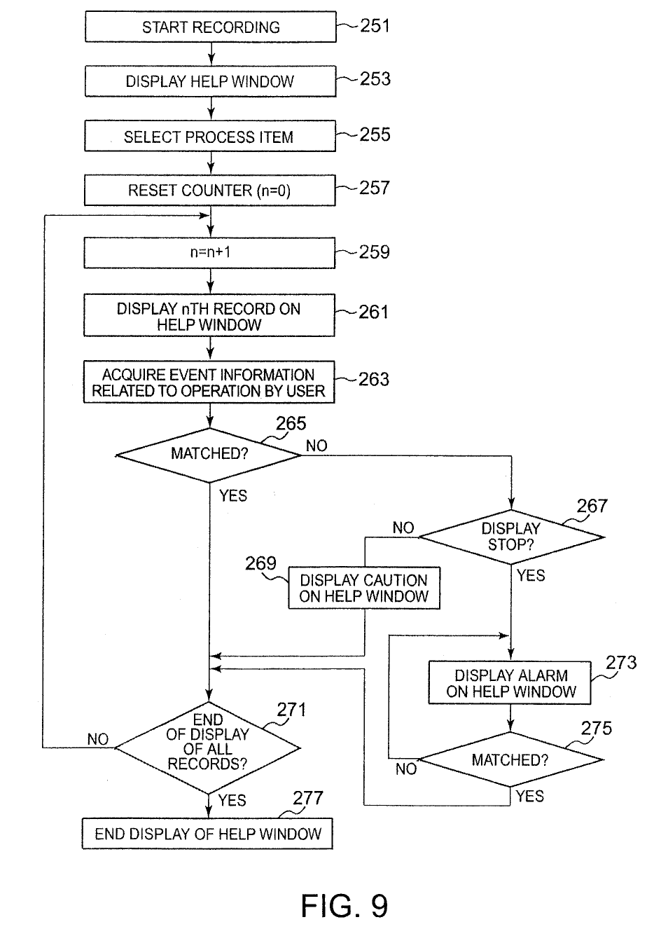

FIG. 9 is a flow chart illustrating a sequence of displaying help information in a computer 100. A user reads and starts one or more applications to be operated from the HDD 111 into the main memory 105 by referring to help information and then displays an application window on the display 109. In this embodiment, it is assumed that the application window 10 as shown in FIGS. 1 and 2 are displayed.

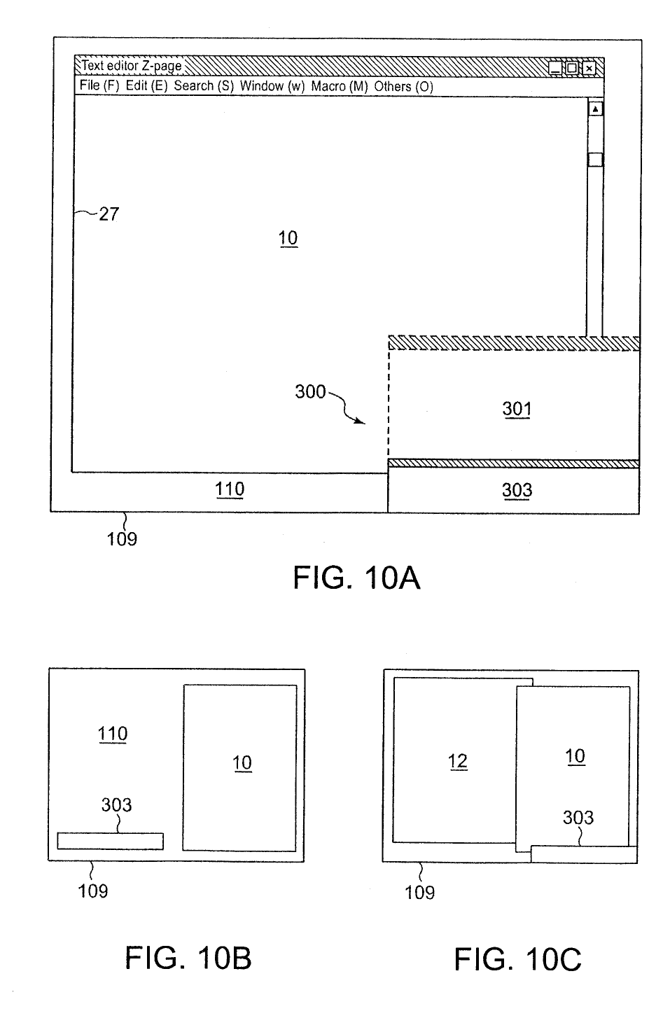

In Block 251, the user reads the display module 133 from the HDD 111 into the main memory 105 and starts the display module 133. The display module 133 is configured to receive event information related to an operation performed by a user with the mouse 117 or the keyboard 119 for the application window 10 from the OS 135. FIG. 10A shows a help window displayed on the display 109. When the display module 133 starts, a help window 300 is displayed in a right and lower corner of the desktop screen 110 displayed on the display 109.

The help window 300 is configured such that a large help window 301 and a small help window 303 are changed in size. The help window 303 is formed with a small window range of 600 dot×100 dot required to display help information required for one operation. When a task bar is displayed on the desktop screen 110, a location of the right and lower corner is determined such that it does not overlap with the task bar. When the application window 10 is displayed in a window mode other than a full screen mode, and when a location in which the help window 303 does not overlap with the application window 10 is present in the desktop screen 110, the help window 303 is displayed in that location, as shown in FIG. 10B. In addition, even when a plurality of application windows are displayed, the display module 133 always displays the help window 303 in the forefront of the screen, as shown in FIG. 10C.

The help window 301 is first displayed immediately after the display module 133 starts. The display module 133 displays a list of process items, which are extracted from the database 209, in the help window 301. In Block 255, when a user selects a process item corresponding to an intended process, the display module 133 reads a file of the selected process item from the HDD 111 into the main memory 105. Subsequently, the display module 133 changes the size of the help window 303 and displays the changed help window 303. In Block 257, an internal counter of the display module 133 is reset to set a count value n to zero.

In Block 259, the display module 133 sets the count value n to n+1. The count value n corresponds to an order of records ordered and organized in a file, other than step numbers of FIG. 7B. In Block 261, the display module 133 displays an n^{th} record in a file of a process item selected by a user. A first record is first displayed. Each record has the same fields as those in the files 203, 205 and 207 of FIG. 7B. The display module 133 displays image operation information, image position information, text information and a comment, which are included in only the n^{th} record, in the help window 303. Here, since the help window 303 is as large as to display only one record, it is easy to operate the application window 10.

Alternatively, the display module 133 may display one or two subsequent consecutive records simultaneously in addition to the n^{th} record. In this case, the help window 303 may be large as to display the required number of records. In addition, the display module 133 may display only the text information and comment among the help information of each record or may display the remaining except for the position information. In addition, the display module 133 may display only the image operation information. Moreover, the help window 303 may be operated to change items of the displayed help information and the size of the help window 303 may be changed depending on the amount of displayed help information. In Block 263, a user performs an n^{th} operation for the application window 10. At this time, the user can read the help information displayed in the help window 303. The display module 133 hooks event information exchanged between the OS 135 and the application window 10 in connection to an event for which the user performs the n^{th} operation.

In Block 265, the display module 133 compares the event information related to the operation performed for the application window 10 by the user with the help information displayed in the help window 303 before the operation. For the comparison, the text information is referred to from the help information. If the event information matches the help information, the flow proceeds to Block 271 where the display module 133 determines whether or not display of all records is ended. If not so, the flow returns to Block 259 where the display module 133 increments the count value n by one and displays help information of a record, which is arranged next in a file read from the database 209 into the main memory 105, in the help window 303. This help information corresponds to an operation performed next by the user in Block 261. Accordingly, the user can refer to help information of the next performed operations displayed in sequence in the help window 303 while operating the application window 10 in sequence for process of a selected process item. When the display module 133 determines in Block 271 that the help information of all records is displayed, the user closes the help window 300 in Block 277 to end the display.

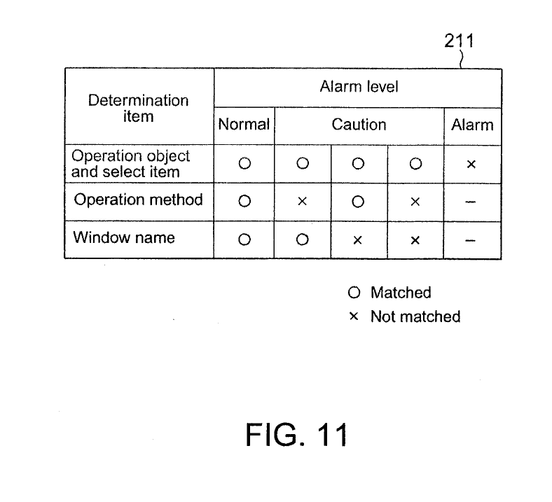

In block 265, if the event information related to the operation performed for the application window 10 by the user does not match the help information displayed in the help window 303 immediately before the operation, the flow proceeds to Block 267 where the display module 133 determines whether or not subsequent displays are stopped. FIG. 11 shows a logic table 211 used to determine whether or not displays are stopped. The logic table 211 sets three kinds of determination items, i.e., operation object and select item, operation method, and title (window name). Contents of these determination items are included in the text information of each record shown in FIG. 6.

If help information related to the three determination items completely match event information related to an operation of a user, the display module 133 determines it as normal and the flow proceeds from Block 265 to Block 271. If not so, the flow proceeds to Block 267 where its importance is estimated to determine whether the importance corresponds to a caution level or an erroneous operation level. If the display module 133 determines in Block 267 that an operation object does not match a select item, the operation of the user is determined as erroneous irrespective of other determination items and the flow proceeds to Block 273 where an alarm is displayed in the help window 303. Since the operation object and the select item are important in performing a predetermined process by a user based on help information, if they do not match each other, the display module 133 determines that useful help information cannot be provided from the select item.

The alarm may be displayed by changing color of the help window, displaying a character or using voice, etc. A user who receives an alarm can change an operation for the application window 10. Alternatively, the user can continue the operation in disregard of the alarm. When the user performs any operation, if event information does not match help information with respect to an operation object and a select item, the flow proceeds from Block 275 to Block 273 and accordingly cannot return to Block 261. In addition, the so-far displayed help information is maintained in the help window 303, but help information related to the next operation is not displayed in the help window 303. If the event information related to the operation by the user with respect to the operation object and the select item matches the help information displayed before the operation, the display module 133 proceeds from Block 275 to Block 271. Accordingly, as shown in FIG. 7, when a redundant record of the help information is deleted, even if a user actually performs the redundant operation for the application window 10, since the event information related to the operation by the user can match the help information in a short time and accordingly the flow can return to Block 261, the display module 133 displays help information for the next operation.

If there is a match between the operation object and the select item but no match between other determination items, a caution is displayed in the help window 303 in Block 269 and then the flow proceeds to Block 271. For example, as a case where operation methods are different from each other, either a keyboard operation or a mouse click operation will be allowed for the application window 10. For example, contents of a corresponding key operation are displayed in several operation objects displayed in the pull down menu 29 of FIG. 1B. Alternatively, the operation for the OK operation object of FIG. 2B may be performed by either mouse button click or an Enter Key of a keyboard.

At this time, if the operation method of help information of the database 209 is a click and the user operates an Enter key for the application window 10 while displaying the help window 303, since there is a high probability of performance of a process intended by the user even if there is no match between operation methods, the display module 133 displays a caution in the help window 303 and then displays help information of the next operation in Block 261. The caution may be displayed in the same manner as the alarm while changing its content.

A file name processed by an application may be included in the title. Accordingly, when a file is edited in any application, in a case where help information recorded in other files in the same application is used, there may be no match between titles. However, if applications are the same, since, in many cases, it is useful to continue display of help information as it is, the display module 133 performs a process like the case where operation methods are different from each other.

In addition, while a user starts an application and performs any operation, the recording module 129 can be also activated. In addition, for example, if a user achieves the purpose of process in disregard of help information in the course of Blocks 273 and 275, the user may start the edition module 131 to generate a file for a new process item from the help information which has been stored in the main memory in a FIFO manner and add the generated file to the database 209.

While the present invention has been shown and described by way of particular preferred embodiments in conjunction with the drawings, the present invention is not limited to the disclosed embodiments. It is to be understood that the present invention may employ any configurations known in the art as long as they can attain the effects of the present invention.

If not otherwise stated herein, it is to be assumed that all patents, patent applications, patent publications and other publications (including web-based publications) mentioned and/or cited herein are hereby fully incorporated by reference herein as if set forth fully herein.

It will be readily understood by those having ordinary skill in the art that embodiments of the instant invention may take the form of an entirely hardware embodiment or an embodiment containing both hardware and software elements. An embodiment of the instant invention that is implemented in software may include, but is not limited to, firmware, resident software, microcode, etc.

Furthermore, embodiments may take the form of a computer program product accessible from a computer-usable or computer-readable medium providing program code for use by or in connection with a computer or any instruction execution system. For the purposes of this description, a computer-usable or computer readable medium can be utilized by any apparatus that can contain, store, communicate, propagate, or transport the program for use by or in connection with the instruction execution system, apparatus, or device.

The medium can be an electronic, magnetic, optical, electromagnetic, infrared, or semiconductor system, (or apparatus or device) or a propagation medium. Examples of a computer-readable medium include a semiconductor or solid state memory, magnetic tape, a removable computer diskette, a random access memory (RAM), a read-only memory (ROM), a rigid magnetic disk and an optical disk. Current examples of optical disks include compact disk-read only memory (CD-ROM), compact disk-read/write (CD-R/W) and DVD.

A data processing system suitable for storing and/or executing program code may include at least one processor coupled directly or indirectly to memory elements through a system bus. The memory elements can include local memory employed during actual execution of the program code, bulk storage, and cache memories which provide temporary storage of at least some program code in order to reduce the number of times code must be retrieved from bulk storage during execution.

Input/output or I/O devices (including but not limited to keyboards, displays, pointing devices, etc.) can be coupled to the system either directly or through intervening I/O controllers.

Network adapters may also be coupled to the system to enable the data processing system to become coupled to other data processing systems or remote printers or storage devices through intervening private or public networks. Modems, cable modems and Ethernet cards are just a few of the currently available types of network adapters.

Many of the functional characteristics of the inventive system described in this specification may be implemented as modules. Modules may include hardware circuits such as one or more processors with memory, programmable logic, and/or discrete components. The hardware circuits may perform hardwired logic functions, execute computer readable programs stored on tangible storage devices, and/or execute programmed functions. The computer readable programs may in combination with a computer system and the other described elements perform the functions of the invention

This disclosure has been presented for purposes of illustration and description but is not intended to be exhaustive or limiting. Many modifications and variations will be apparent to those of ordinary skill in the art. The embodiments were chosen and described in order to explain principles and practical application, and to enable others of ordinary skill in the art to understand the disclosure for various embodiments with various modifications as are suited to the particular use contemplated.

What is claimed is:

1. A machine implemented method comprising:
storing a plurality of help information records in a memory of the machine, the plurality of help information records comprising: a first record and at least one subsequent record;
displaying an application window on a display device of the machine;
displaying the first record in a help window on the display device;
acquiring event information generated by an input operation at a user interface associated with a user operating an application displayed in the application window; and
displaying the at least one subsequent record in response to the acquired event information in the help window.

2. The method according to claim 1, wherein help information of a help information record displayed in the help window comprises image operation information related to an operation object displayed in the application window.

3. The method according to claim 2, wherein the image operation information comprises an image of an area of the application window.

4. The method according to claim 2, wherein the help information comprises image position information representing a display position of the operation object displayed in the application window.

5. The method according to claim 1, wherein the help window is displayed in a forefront with respect to all application windows appearing on the display device.

6. The method according to claim 1, further comprising:
comparing the first record to the acquired event information; and
providing an alarm if a mismatch is ascertained between the first record and the acquired event information.

7. The method according to claim 6, wherein the step of providing an alarm further comprises stopping the displaying of the at least one subsequent record.

8. The method according to claim 7, further comprising:
displaying the at least one subsequent record upon acquiring event information matching the first record.

9. The method according to claim 1, wherein the plurality of help information records further comprise a plurality of process items corresponding to a process for executing an application.

10. The method according to claim 1, further comprising:
recording as help information records help information related to a series of operations for operating an application.

11. An apparatus comprising:
a processor;
a display device;
a user interface; and
a memory;
wherein the memory tangibly stores a program of instructions executed by the processor to perform method steps, the method steps comprising:
storing a plurality of help information records in the memory, the plurality of help information records comprising: a first record and at least one subsequent record;
displaying an application window on the display device;
displaying the first record in a help window on the display device;
acquiring event information generated by an input operation at the user interface associated with a user operating an application displayed in the application window; and
displaying the at least one subsequent record in response to the acquired event information in the help window.

12. The apparatus according to claim 11, wherein help information of a help information record displayed in the help window comprises image operation information related to an operation object displayed in the application window.

13. The apparatus according to claim 12, wherein the image operation information comprises an image of an area of the application window.

14. The apparatus according to claim 12, wherein the help information comprises image position information representing a display position of the operation object displayed in the application window.

15. The apparatus according to claim 11, wherein the help window is displayed in a forefront with respect to all application windows appearing on the display device.

16. The apparatus according to claim 11, wherein the program of instructions executed by the processor further performs method steps comprising:
comparing the first record to the acquired event information; and
providing an alarm if a mismatch is ascertained between the first record and the acquired event information.

17. The apparatus according to claim 16, wherein the step of providing an alarm further comprises stopping the displaying of the at least one subsequent record.

18. The apparatus according to claim 17, wherein the program of instructions executed by the processor further performs method steps comprising:
displaying the at least one subsequent record upon acquiring event information matching the first record.

19. The apparatus according to claim 11, wherein the plurality of help information records further comprise a plurality of process items corresponding to a process for executing an application.

20. A tangible program storage device readable by machine, tangibly embodying a program of instructions executable by the machine to perform method steps, said method steps comprising:
storing a plurality of help information records in a memory of the machine, the plurality of help information records comprising: a first record and at least one subsequent record;
displaying an application window on a display device of the machine;
displaying the first record in a help window on the display device;
acquiring event information generated by an input operation at a user interface associated with a user operating an application displayed in the application window; and
displaying the at least one subsequent record in response to the acquired event information in the help window.
